(19) United States
(12) Patent Application Publication
(10) Pub. No.: US 2026/0085078 A1
(43) Pub. Date: Mar. 26, 2026

(54) NON-AQUEOUS SYNTHESIS OF SILYLCARBONATE SOLVENTS

(71) Applicant: UCHICAGO ARGONNE, LLC, Chicago, IL (US)

(72) Inventors: Trevor L. Dzwiniel, Carol Stream, IL (US); Amber Tabaka, Downers Grove, IL (US); Krzysztof Z. Pupek, Plainfield, IL (US)

(73) Assignee: UCHICAGO ARGONNE, LLC, Chicago, IL (US)

(21) Appl. No.: 18/896,068

(22) Filed: Sep. 25, 2024

(51) Int. Cl. C07F 7/08

(52) U.S. Cl. CPC C07F 7/0827; C07F 7/081

(57) ABSTRACT

A system and method of making a silylcarbonate compound, the method including reacting trialkylsilylalcohol with alkyl chloroformate in the presence of a base at an elevated temperature to form the silylcarbonate compound.

### STATEMENT OF GOVERNMENT INTEREST

This invention was made with government support under PRJ1001532 awarded by the United States Department of Energy. The government has certain rights in the invention.

### TECHNICAL FIELD

The present technology is generally related to methods of forming silyl carbonates, more specifically alkyl(trimethylsilyl) carbonates, and systems and methods using these silyl carbonates.

### BACKGROUND

High-voltage, high-capacity cathodes have the potential to provide high power lithium-ion batteries. But the use of these cathodes has been constrained by their propensity to degrade organic electrolyte solvents. Moreover, these solvents may exhibit flammability issues, particularly when subjected to elevated temperatures. To address these concerns, various additives have been proposed to enhance thermal stability and flame resistance. Nonetheless, these additives frequently impair the performance of the battery, leading to a compromise between fire suppression and operational efficiency.

### SUMMARY

In an aspect, a method is provided for making a compound where the method includes mixing a solvent, a trialkylsilylalcohol, an alkyl chloroformate, and a base to form a reaction mixture; and heating the reaction mixture to form a heated mixture comprising the compound having the structure of Formula I;

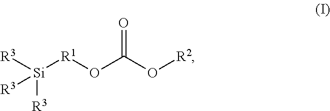

wherein R¹ is CH₂, CH₂CH₂, or CH₂CH₂CH₂; R² is C1-C4 alkyl, C2-C4 alkenyl, a substituted aryl, or an unsubstituted aryl; and R³ is an alkyl. In some embodiments, R² may be CH₃, CH₂CH₃, CH₂CH₂CH₃, or CH₂(CH₃)CH₃. In some embodiments, R³ is C1-C8 alkyl.

In another aspect, a system includes a reactor configured to control a reaction mixture disposed in the reactor at an elevated temperature; a pumping assembly in fluid communication with a plurality of reactant reservoirs, the pumping assembly configured to pump a plurality of reactants from the plurality of reactant reservoirs to the reactor; and the plurality of reactant reservoirs comprising a solvent reservoir, a base reservoir, a trialkylsilylalcohol reservoir, and an alkyl chloroformate reservoir; wherein the system is configured to produce the compound having the structure of Formula I.

### BRIEF DESCRIPTION OF DRAWINGS

FIG. 1 is a graph of relative amounts of starting material, side products, and products in mixtures following reaction using different bases. The reactants were 1.0 equivalent (eq.) trimethylsilylmethanol (TMS-CH₂OH) and 1.0 eq. ethyl chloroformate in the presence of 1.0 eq. base in acetonitrile solvent at 10 mL/g. Equivalents are mole ratio equivalents based on TMS-CH₂OH, where 1.0 eq. means 1 mole reagent per mole of trimethylsilylalkyl. The reaction temperature was 75° C. and the reaction time was 3 hours.

FIG. 2 is a graph of relative amounts of starting material, side products, and products in mixtures following reaction using different solvents. The reactants were 1.0 eq. TMS-CH₂OH and 1.2 eq. ethyl chloroformate in the presence of 1.2 eq. K₃PO₄ base and in solvent at 10 mL/g. The reaction temperature was 50° C. and the reaction time was 2 hours.

FIG. 3 is a graph of conversion efficiency (%) with different amounts of K₃PO₄ in the mixture. The reactants were 1.0 eq. trimethylsilylmethanol (TMS-CH₂OH) and 1.2 eq. ethyl chloroformate in the presence of different concentrations of base in acetonitrile solvent at 10 mL/g. The reaction temperature was 50° C. and the reaction time was 2 hours.

FIGS. 4A and 4B are graphs characterizing the product of the reaction of 1.0 eq. trimethylsilylmethanol (TMS-CH₂OH) and 1.2 eq. ethyl chloroformate in the presence of 1.2 eq K₃PO₄ in acetonitrile solvent at 10 mL/g, as disclosed in Example 1. FIG. 4A is a graph of gas chromatography analysis of the product. FIG. 4B is a graph of mass spectroscopy of the product.

FIGS. 5A-5D are graphs characterizing the product of the kilogram-scale reaction disclosed in Example 6. FIG. 5A is a graph of gas chromatography analysis of the product of the reaction using commercially available trimethylsilyl methanol. FIG. 5B is a graph of gas chromatography analysis of the product of the reaction using in-house-synthesized trimethylsilyl methanol. FIG. 5C is a graph of gas chromatography analysis of the product of the reaction using commercially available trimethylsilyl methanol, indicating the presence of an acetate impurity. FIG. 5D is a graph of gas chromatography analysis of the product of the reaction after distillation with a 10-plate Oldershaw column.

FIG. 6 is a schematic of a system for manufacturing silylcarbonate solvents.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments, and does not pose a limitation on the scope of the claims unless otherwise stated. No language in the specification should be construed as indicating any non-claimed element as essential.

In general, “substituted” refers to an alkyl, alkenyl, alkynyl, aryl, or ether group, as defined below (e.g., an alkyl group) in which one or more bonds to a hydrogen atom contained therein are replaced by a bond to non-hydrogen or non-carbon atoms. Substituted groups also include groups in which one or more bonds to a carbon(s) or hydrogen(s) atom are replaced by one or more bonds, including double or triple bonds, to a heteroatom. Thus, a substituted group will be substituted with one or more substituents, unless otherwise specified. In some embodiments, a substituted group is substituted with 1, 2, 3, 4, 5, or 6 substituents. Examples of substituent groups include: halogens (i.e., F, Cl, Br, and I); hydroxyls; alkoxy, alkenoxy, alkynoxy, aryloxy, aralkyloxy, heterocyclyloxy, and heterocyclylalkoxy groups; carbonyls (oxo); carboxyls; esters; urethanes; oximes; hydroxylamines; alkoxyamines; aralkoxyamines; thiols; sulfides; sulfoxides; sulfones; sulfonyls; sulfonamides; amines; N-oxides; hydrazines; hydrazides; hydrazones; azides; amides; ureas; amidines; guanidines; enamines; imides; isocyanates; isothiocyanates; cyanates; thiocyanates; imines; nitro groups; nitriles (i.e., CN); and the like.

As used herein, “alkyl” groups include straight chain and branched alkyl groups having from 1 to about 20 carbon atoms, and typically from 1 to 12 carbons or, in some embodiments, from 1 to 8 carbon atoms. As employed herein, “alkyl groups” include cycloalkyl groups as defined below. Alkyl groups may be substituted or unsubstituted. Examples of straight chain alkyl groups include methyl, ethyl, n-propyl, n-butyl, n-pentyl, n-hexyl, n-heptyl, and n-octyl groups. Examples of branched alkyl groups include, but are not limited to, isopropyl, sec-butyl, t-butyl, neopentyl, and isopentyl groups. Representative substituted alkyl groups may be substituted one or more times with, for example, amino, thio, hydroxy, cyano, alkoxy, and/or halo groups such as F, Cl, Br, and I groups. As used herein the term haloalkyl is an alkyl group having one or more halo groups. In some embodiments, haloalkyl refers to a per-haloalkyl group.

Cycloalkyl groups are cyclic alkyl groups such as, but not limited to, cyclopropyl, cyclobutyl, cyclopentyl, cyclohexyl, cycloheptyl, and cyclooctyl groups. In some embodiments, the cycloalkyl group has 3 to 8 ring members, whereas in other embodiments the number of ring carbon atoms range from 3 to 5, 6, or 7. Cycloalkyl groups may be substituted or unsubstituted. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups as defined above. Representative substituted cycloalkyl groups may be mono-substituted or substituted more than once, such as, but not limited to: 2,2-; 2,3-; 2,4-; 2,5-; or 2,6-disubstituted cyclohexyl groups or mono-, di-, or tri-substituted norbornyl or cycloheptyl groups, which may be substituted with, for example, alkyl, alkoxy, amino, thio, hydroxy, cyano, and/or halo groups.

Alkenyl groups are straight chain, branched or cyclic alkyl groups having 2 to about 20 carbon atoms, and further including at least one double bond. In some embodiments alkenyl groups have from 1 to 12 carbons, or, typically, from 1 to 8 carbon atoms. Alkenyl groups may be substituted or unsubstituted. Alkenyl groups include, for instance, vinyl, propenyl, 2-butenyl, 3-butenyl, isobutenyl, cyclohexenyl, cyclopentenyl, cyclohexadienyl, butadienyl, pentadienyl, and hexadienyl groups, among others. Alkenyl groups may be substituted similarly to alkyl groups. Divalent alkenyl groups, i.e., alkenyl groups with two points of attachment, include, but are not limited to, CH—CH═CH₂, C═CH₂, or C═CHCH₃.

As used herein, “aryl”, or “aromatic,” groups are cyclic aromatic hydrocarbons that do not contain heteroatoms. Aryl groups include monocyclic, bicyclic, and polycyclic ring systems. Thus, aryl groups include, but are not limited to, phenyl, azulenyl, heptalenyl, biphenylenyl, indacenyl, fluorenyl, phenanthrenyl, triphenylenyl, pyrenyl, naphthacenyl, chrysenyl, biphenyl, anthracenyl, indenyl, indanyl, pentalenyl, and naphthyl groups. In some embodiments, aryl groups contain 6-14 carbons, and in others from 6 to 12 or even 6-10 carbon atoms in the ring portions of the groups. The phrase “aryl groups” includes groups containing fused rings, such as fused aromatic-aliphatic ring systems (e.g., indanyl, tetrahydronaphthyl, and the like). Aryl groups may be substituted or unsubstituted.

There remains a significant demand for advanced electrolyte solvents characterized by several critical properties: a broad electrochemical stability window, high ionic conductivity coupled with minimal electronic conductivity, low vapor pressure, low viscosity across an extensive temperature range, and reduced flammability (e.g., a higher flash point relative to conventional carbonate solvents). The silyl carbonate solvents disclosed herein are designed to address this persistent need.

Furthermore, previous attempts to manufacture such silyl carbonate solvents had yields too low for efficient manufacture due to the formation of substantial amounts of byproducts. Furthermore, previous methods to manufacture such solvents introduced water during synthesis workup, potentially introducing water into the resulting solvent, which may be detrimental to the performance of a lithium-ion battery in which the solvent is used.

Therefore, the present technology provides a method of manufacturing such silyl carbonate solvents with high conversion efficiency (e.g., greater than 90%, 95%, or 98% conversion efficiency) and without any steps that introduce substantial amounts of water (e.g., greater than 5 wt. %, 2 wt. %, 1 wt. %, 0.5 wt. %, 0.1 wt. %, 0.01 wt. %, or 0.001 wt. %) into the product. The methods disclosed herein are reproducible and may be scaled for industrial manufacture.

The silylcarbonate compounds disclosed herein having the structure of Formula (I)

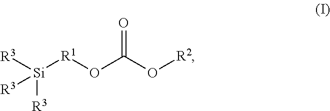

wherein R¹ is CH₂, CH₂CH₂, or CH₂CH₂CH₂; R² is a C1-C4 alkyl, C2-C4 alkenyl, a substituted aryl, or an unsubstituted aryl; and R³ is an alkyl.

In some embodiments of Formula (I), R¹ is CH₂, CH₂CH₂, or CH₂CH₂CH₂. In other embodiments, R¹ is CH₂ where the trialkylsilylalcohol comprises trimethylsilylmethanol. In further embodiments, R¹ is CH₂CH₂ where the trialkylsilylalcohol comprises trimethylsilylethanol. In yet other embodiments, R¹ is CH₂CH₂CH₂ where the trialkylsilylalcohol comprises trimethylsilylpropanol.

In some embodiments of Formula (I), R² may be C1-C4 alkyl, where illustrative, but non-limiting, examples of a C1-C4 alkyl include CH₃, CH₂CH₃, CH₂CH₂CH₃, CH₂(CH₃)CH₃, CH₂CH₂CH₂CH₃, CH₂CH(CH₃)₂, and C(CH₃)₃. In some embodiments of Formula (I), R² is a C2-C4 alkenyl, where examples of the C2-C4 alkenyl include CHCH₂, CH₂CHCH₂, CH₂CH₂CHCH₂, and CH₂CHCHCH₃. In some embodiments of Formula (I), R² is a substituted or unsubstituted aryl, where examples of aryls include phenyl, and substituted groups include nitro groups.

In some embodiments of Formula (I), R³ is C1-C8 alkyl, where illustrative, but non-limiting, examples of C1-C8 alkyl include methyl, ethyl, propyl, isopropyl, and n-butyl. In some embodiments of Formula (I), R³ is methyl.

For example, silylcarbonate compounds disclosed herein may have the structure of any one of Formulas (II)-(X)

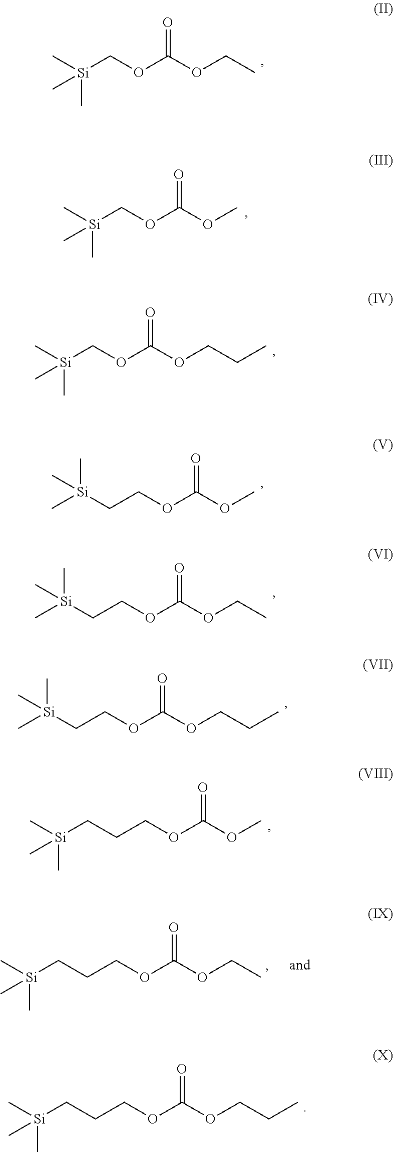

Such compounds were previously synthesized via a procedure that included transesterification of dialkyl carbonates with a trialkylsilylalcohol. That procedure resulted in the formation of a substantial amount of the side products of the di(silyl) material, leading to inefficient reactions and difficulty separating and isolating the desired silylcarbonate product have the structure of Formula (I). Furthermore, these previous procedures typically relied on aqueous washing and/or extraction steps, potentially introducing water into the product, which may be detrimental to battery performance. Furthermore, previous methods to synthesize such compounds typically used highly hazardous reagents (e.g., butyl lithium or lithium hydride) to deprotonate and react with alkyl tosylate to form the silylcarbonate product. For example, ethyl (trimethylsilyl) carbonate (ETMSMC) was previously synthesized via transesterification of diethyl carbonate and trimethylsilyl methanol (TMS-methanol). The manufacturing procedure resulted in the formation of a substantial amount (e.g., greater than 10 wt. %, 20 wt. %, 30 wt. %, or 40 wt. %) of side product of di(silyl) material, leading to more difficult separations and isolations.

The methods disclosed herein address the above issues in synthesizing silylcarbonates. In particular, the present technology includes methods of making silylcarbonates without the use of water or highly hazardous reagents during reaction or synthesis workup, and may provide high conversion efficiency (e.g., greater than 90%, 95%, or 98% conversion efficiency). Since the method does not use water, the silylcarbonate may not introduce water into the lithium-ion battery in which the silylcarbonate is used. Reaction workup may include filtration followed by a single distillation. These methods may result in higher yields with higher purity and may use less starting material. These methods may be scaled from bench-scale to industrial-scale.

Disclosed herein are methods of making a silylcarbonate compound having the structure of Formula (I). The methods disclosed herein may include forming a reaction mixture comprising a solvent, trialkylsilylalcohol, alkyl chloroformate, and a base in a solvent; reacting the trialkylsilylalcohol with the alkyl chloroformate in the presence of the base at an elevated temperature to form a heated mixture comprising the compound having the structure of Formula (I).

The trialkylsilylalcohol may be trimethylsilylmethanol, trimethylsilylethanol, trimethylsilylpropanol, trimethylsilylisopropanol, triethylsilylmethanol, triethylsilylethanol, triethylsilylpropanol, triethylsilylisopropanol, tripropylsilylmethanol, tripropylsilylethanol, tripropylsilylpropanol, or tripropylsilylisopropanol. The alkyl chloroformate may be methyl chloroformate, ethyl chloroformate, or propyl chloroformate. The silylcarbonates made using this method may contain less than an appreciable amount of water and are preferably anhydrous.

The elevated temperature may be about 1° C. to about 40° C. less than the solvent's boiling point, e.g., about 2° C. to about 35° C., about 4° C. to about 30° C., about 8° C. to about 15° C., or about 1° C., 2° C., 3° C., 4° C., 5° C., 6° C., 7° C., 8° C., 9° C., 10° C., 15° C., 20° C., 25° C., 30° C., 35° C., or 40° C. less than the solvent's boiling point at 1 atm.

The step of forming the reaction mixture may include combining the base and the trialkylsilylalcohol in the solvent to form a homogeneous or heterogeneous mixture; and mixing the alkyl chloroformate with the solution at a temperature of about 15° C. to about 36° C. The step of adding the trialkylsilylalcohol to the solvent may be exothermic, so the temperature may be monitored. The alkyl chloroformate may be added slowly (e.g., via addition funnel) to the mixture of solvent, base, and trialkylsilylalcohol at a temperature of about 15° C. to about 36° C. to form the reaction mixture. Following formation of the reaction mixture, the reaction mixture may be heated at a temperature of about 2° C. to about 35° C. less than the solvent's boiling point with agitation (e.g., stirring) for a predetermined reaction time (e.g., 1 hour to about 12 hours). Following heating, the heated mixture may be stirred at a temperature of about 15° C. to about 36° C. for an additional period to further the reaction.

Following reaction, the product silylcarbonyl may be worked up to isolate or substantially isolate the product. The heated mixture may be filtered (e.g., by contacting with diatomaceous earth) to remove at least a portion of the base from the heated mixture. In some embodiments, the heated mixture may be filtered to remove at least 50 wt %, 60 wt %, 70 wt %, 80 wt %, 90 wt %, 95 wt %, 98 wt %, 99 wt %, or 99.9 wt % of the base. Further, the heated mixture may be distilled to remove about 10 wt % to about 99.9 wt % of the solvent from the heated mixture. In some embodiments, the heated mixture may be filtered to remove at least 50 wt %, 60 wt %, 70 wt %, 80 wt %, 90 wt %, 95 wt %, 98 wt %, 99 wt %, or 99.9 wt % of the solvent.

R² in Formula (I) is CH₃ where the alkyl chloroformate comprises methyl chloroformate. R² is CH₂CH₃ where the alkyl chloroformate comprises ethyl chloroformate. R² is CH₂CH₂CH₃ where the alkyl chloroformate comprises propyl chloroformate. For example, the silylcarbonate compound produced by the method of the present technology may have the structure of Formula (III), referred to as ethyl (trimethylsilylmethyl) carbonate (ETMSMC), where the trialkylsilylalcohol starting material is trimethylsilylmethanol and the alkyl chloroformate starting material is methyl chloroformate.

The base used in the reaction mixture and present during reaction may be a base strong enough to facilitate the reaction. Illustrative bases include, but are not limited to, 2,3,4,6,7,8,9,10-octahydropyrimido[1,2-a]azepine (also called 1,8-diazabicyclo[5.4.0]undec-7-ene, DBU), triethylamine, potassium phosphate, N,N-diisopropylethylamine (DIPEA), sodium carbonate, potassium carbonate, or a combination of two or more thereof. For example, the base may be potassium phosphate. The amount of the base may be 0.5 base equivalents (eq.) to about 2.0 eq., e.g., 0.7 eq to about 1.2 eq., 1.0 eq. to about 1.2 eq, about 0.7 eq., about 0.8 eq., about 1.0 eq., and about 1.2 eq. The base may be present in the reaction mixture in a molar ratio relative to the trialkylsilylalcohol of about 0.8 to about 2:1, about 1.1:1 to about 2:1, or about 1.0:1.0 to about 1.2:1. Depending on the base used, the base may not be dissolved in the solvent. For example, the potassium phosphate may be in solid form in the reaction mixture.

The solvent in the reaction mixture may have a boiling point suitable for distillation. For example, at a pressure of about 1.0 atm the boiling point of the solvent may be about 30° C. to about 120° C., e.g., about 32° C. to about 100° C., about 32° C. to about 90° C. Illustrative solvents include tetrahydrofuran (THF), 1,2-dimethoxyethane (DME), acetonitrile, ethyl acetate, dichloromethane (DCM), or a combination of two or more thereof. For example, the solvent may be DME and the reaction temperature may be about 50° C. to about 80° C.

The method of forming the silylcarbonate may provide a product yield of about 40% to about 70% with a purity of about 99.9% to about 99.99%. Further, the method may provide a starting material conversion of about 90% to about 98%.

The solvents described herein can be utilized with any combination of anode and cathode in a lithium-ion battery electrochemical cell that uses a non-aqueous electrolyte. Electrolyte solvents for non-aqueous electrochemical cells and batteries are described herein. A preferred solvent comprises a compound of Formula (I) as described herein. The solvents of Formula (I) have good solubilizing characteristics for dissolving salts commonly used in electrolytes for lithium battery electrolytes. The solvents of Formula (I) also have excellent chemical compatibility and electrochemical stability with anode and cathode materials used in lithium batteries properties during battery charging and discharging. The silyl groups of the solvents of Formulas (I) also provide reduced flammability relative to common organic carbonates used in lithium battery applications.

In any of the above embodiments, the electrolyte may further include a lithium salt. Illustrative lithium salts include, but are not limited to lithium alkyl fluorophosphates; lithium alkyl fluoroborates; lithium 4,5-dicyano-2-(trifluoromethyl)imidazole; lithium 4,5-dicyano-2-methylimidazole; trilithium 2,2′,2″-tris(trifluoromethyl)benzotris(imidazolate); LiN(CN)₂; Li(CF₃CO₂); Li(C₂F₅CO₂); LiCF₃SO₃; LiCH₃SO₃; LiN(SO₂CF₃)₂; LiN(SO₂F)₂; LiC(CF₃SO₂)₃; LiN(SO₂C₂F₅)₂; LiClO₄; LiBF₄; LiAsF₆; LiPF₆; LiBF₂(C₂O₄), LiB(C₂O₄)₂, LiPF₂(C₂O₄)₂, LiPF₄(C₂O₄), LiAsF₆, CsF, CsPF₆, LiN(SO₂CF₃)₂, LiN(SO₂F)₂, Li₂(B₁₂X₁₂₋ₚHₚ); Li₂(B₁₀X_{10-p′}H_{p′}); or a mixture of any two or more thereof, wherein X may be independently at each occurrence a halogen, p may be 0, 1, 2, 3, 4, 5, 6, 7, 8, 9, 10, 11, or 12, and p′ may be 0, 1, 2, 3, 4, 5, 6, 7, 8, 9, or 10. In some embodiments, the salt may be LiPF₆, LiBF₄, LiN(SO₂CF₃)₂, or LiN(SO₂F)₂. The salt may be present in the electrolyte at any amount including from about 0.5 M to 5 M. This may include from about 1 M to about 2 M.

The electrolytes described herein may comprise an electrolyte salt dissolved in a non-aqueous solvent comprising a compound of Formula (I). In any embodiment, the solvent of the electrolyte may also comprise one or more additional solvent. The solvent may be a polar aprotic solvent. Such polar aprotic solvents may include, but are not limited to, organic carbonates, fluorinated carbonates, ethers, fluorinated ethers, glymes, other sulfones, organic sulfates, esters, cyclic esters, fluorinated esters, nitriles, amides, dinitriles, fluorinated amides, carbamates, fluorinated carbamates, cyanoester compounds, pyrrolidinium-based ionic liquids, piperidinium-based ionic liquids, imidazolium-based ionic liquids, ammonium-based ionic liquids, phosphonium-based ionic liquids, or cyclic phosphonium-based ionic liquids. In some embodiments, the solvent may be a carbonate, a sulfone, a siloxane, a silane, an ether, an ester, a lactone, ionic liquids, any fluorinated derivatives thereof, or a blend of any two or more such solvents. For example, the solvent may include one or more of dimethyl carbonate, ethyl methyl carbonate (EMC), diethyl carbonate, methyl propyl carbonate, ethyl propyl carbonate, dipropyl carbonate, dimethoxyethane, triglyme, propylene carbonate (PC), dimethylvinylene carbonate, tetraethyleneglycol, dimethyl ether, polyethylene glycols, γ-butyrolactone, ethylene carbonate (EC), difluoroethylene carbonate (DFEC), fluoroethylmethylcarbonate (FEMC), bis(trifluoroethyl) carbonate, bis(pentafluoropropyl) carbonate, trifluoroethyl methyl carbonate, pentafluoroethyl methyl carbonate, heptafluoropropyl methyl carbonate, perfluorobutyl methyl carbonate, trifluoroethyl ethyl carbonate, pentafluoroethyl ethyl carbonate, heptafluoropropyl ethyl carbonate, or perfluorobutyl ethyl carbonate, as well as fluorinated solvents and fluorinated version of any of the foregoing solvents with being just two examples. In some embodiments, the non-aqueous solvent is one or more of PC, EC, EMC, DFEC, or FEMC. In some embodiments, the solvent is a piperidinium-based ionic liquid or an imidazolium-based ionic liquid.

The solvent can comprise a single solvent compound or a mixture of two or more solvent compounds. Preferably, the compound of Formula (I) comprises about 2% to about 100% of the solvent portion of the electrolyte on a weight basis (wt %), when the compound of Formula (I) is utilized for its ability to dissolve the electrolyte salt. When utilized as an additive e.g., to modify the solid electrolyte interface (SEI) layer, the compound of Formula (I) preferably is present at a concentration of about 0.05 wt % to about 2 wt % (more preferably about 0.1 to about 0.5 wt %).

The electrolytes can be incorporated in a lithium-ion electrochemical cell comprising a cathode (positive electrode), an anode (negative electrode), and a porous separator between the cathode and anode. The electrolyte may be used with any anode or cathode compositions useful in lithium-ion batteries. The anode may include an anode active material, and may also include a binder. The cathode may include a cathode active material and a binder. The secondary electrochemical cells may further include a separator between the cathode and the anode. The secondary electrochemical cells may further include current collectors for one or all electrodes.

The cathode active material may be any of a wide variety of lithium-containing cathode active materials including lithium nickel-manganese-cobalt oxide compositions, and the like. In some embodiments, the cathode active material includes, but is not limited to a spinel, olivine, Li_{1+w}MnₓNi_{y}Co_{z}O₂, LiMn_{x′}Ni_{y′}O₄, or a′Li₂MnO₃·(1-a′)LiMO₂, wherein 0<w<1, 0≤x<1, 0≤y<1, 0≤z<1, and x+y+z=1; 0≤x′<2, 0≤y′<2, and x′+y′=2; and 0≤a′<2. As used herein, a “spinel” refers to a manganese-based spinel such as, Li₁₊ₓMn_{2-y}Me_{z}O₄₋ₕAₖ, wherein Me is Al, Mg, Ti, B, Ga, Si, Ni, or Co; A is S or F; and wherein 0≤x≤0.5, 0≤y≤0.5, 0≤z≤0.5, 0≤h≤0.5, and 0≤k≤0.5. The term “olivine” refers to an iron-based olivine such as, LiFe₁₋ₓMe_{y}PO₄₋ₕAₖ, wherein Me is Al, Mg, Ti, B, Ga, Si, Ni, or Co; A is S or F; and wherein 0≤x≤0.5, 0≤y≤0.5, 0≤h≤0.5, and 0≤k≤0. Other cathode active materials may include any of the following, alone or in combination with any of the cathode active materials described herein, a spinel, an olivine, a carbon-coated olivine LiFePO₄, LiMn_{0.5}Ni_{0.5}O₂, LiCoO₂, LiNiO₂, LiNi₁₋ₓCo_{y}Me_{z}O₂, LiNi_{α}Mn_{β}Co_{γ}O₂, LiMn₂O₄, LiFeO₂, LiNi_{0.5}Me_{1.5}O₄, Li_{1+x′}NiₕMnₖCo₁Me²_{y′}O_{2-z′}F_{z′}, VO₂ or E_{x″}F₂(Me₃O₄)₃, LiNiₘMnₙO₄, wherein Me is Al, Mg, Ti, B, Ga, Si, Mn, or Co; Me² is Mg, Zn, Al, Ga, B, Zr, or Ti; E is Li, Ag, Cu, Na, Mn, Fe, Co, Ni, or Zn; F is Ti, V, Cr, Fe, or Zr; wherein 0≤x≤0.3; 0≤y≤0.5; 0≤z≤0.5; 0≤m≤2; 0≤n≤2; 0≤x′≤0.4; 0≤α≤1; 0≤β≤1; 0≤γ≤1; 0≤h≤1; 0≤k≤1; 0≤1≤1; 0≤y′≤0.4; 0≤z′≤0.4; and 0≤x″≤3; with the proviso that at least one of h, k and l is greater than 0. In any embodiment, the cathode active material may include a layered lithium nickel cobalt manganese oxide, layered lithium nickel cobalt aluminum oxide, spinel lithium nickel manganese oxide, lithium iron phosphates, lithium cobalt phosphates, lithium manganese phosphates, lithium cobalt oxide, lithium nickel oxide, lithium manganese oxide, or a mixture of any two of more thereof.

The cathode active material may also be accompanied by a conductive carbon material such as natural graphite, synthetic graphite, hard carbon, amorphous carbon, soft carbon, mesocarbon microbeads (MCMB), acetylene black, Ketjen™ black, carbon black, mesoporous carbon, porous carbon matrix, carbon nanotube, carbon nanofiber, and graphene.

Illustrative anode active materials include conductive carbon, Li⁰, Sb⁰, Si⁰, Si—C, SiO, Sn⁰, tin oxide, Li₄Ti₅O₁₂, a composite tin alloy, a transition metal oxide, a lithium metal nitride, phosphorous, a phosphorous-carbon composite, or a mixture of any two or more thereof. The conductive carbon may include natural graphite, synthetic graphite, hard carbon, amorphous carbon, soft carbon, mesocarbon microbeads (MCMB), acetylene black, Ketjen black, carbon black, mesoporous carbon, porous carbon matrix, carbon nanotube, carbon nanofiber, graphene, and mixtures of any two or more thereof.

Illustrative binder materials for the cathode and/or anode include, but are not limited to polyvinylidene fluoride (PVDF), polyvinyl alcohol (PVA), polyethylene, polystyrene, polyethylene oxide, polytetrafluoroethylene (Teflon), polyacrylonitrile, polyimide, styrene butadiene rubber (SBR), carboxy methyl cellulose (CMC), a copolymer of any two or more such polymers, and a blend of any two or more such polymers.

Illustrative separator materials include, but are not limited to, a microporous or modified polymer separator. Illustrative separators include, but are not limited to, Celgard® 2325, Celgard® 2400, Celgard® 3501, and glass fiber separators.

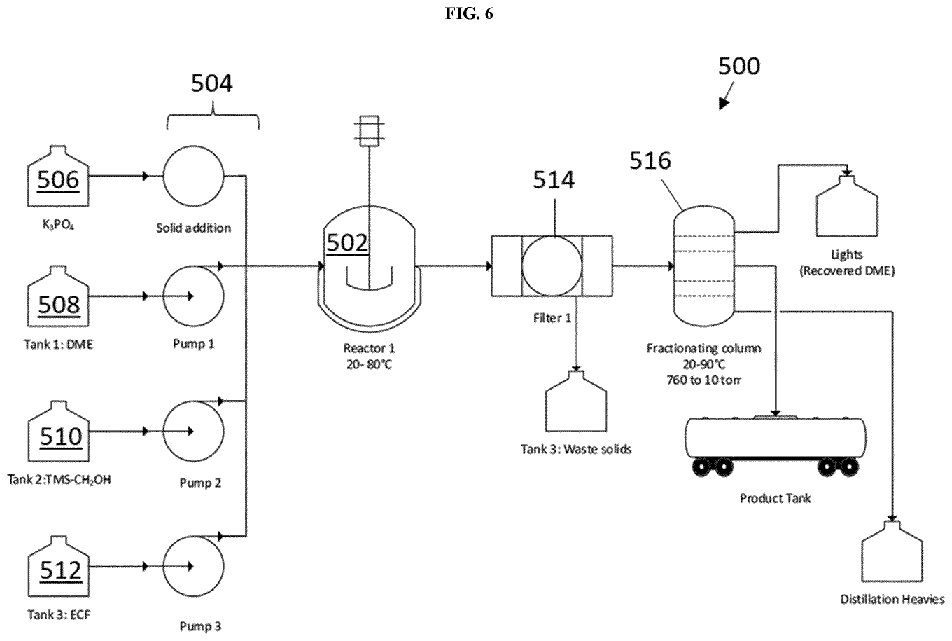

In another aspect, a system for forming the silylcarbonate product using the method of the present technology is disclosed. FIG. 6 is a schematic of the system 500 for manufacturing silylcarbonate solvents. The system 500 includes a reactor 502, a pumping assembly 504, and a plurality of reactant reservoirs 506-512. The reactor 502 may be configured to control a reaction mixture disposed in the reactor at a temperature of about 2° C. to about 35° C. less than the solvent's boiling point during the reaction. The pumping assembly 504 may be in fluid communication with the plurality of reactant reservoirs. The pumping assembly 504 may be configured to pump a plurality of reactants from the plurality of reactant reservoirs to the reactor 502. The plurality of reactant reservoirs may include a base reservoir 506, a solvent reservoir 508, a trialkylsilylalcohol reservoir 510, and an alkyl chloroformate reservoir 512. The system is configured to make a compound having the structure of Formula (I).

The system 500 may further include a filter assembly 514 configured to remove at least a portion of the base from the heated mixture. The filter assembly 514 may include diatomaceous earth as the filter media to remove the base. The system 500 may further include a fractionating column 516 configured to remove about 10 wt % to about 99 wt % of the solvent from the heated mixture. The solvent reservoir 508 may include tetrahydrofuran (THF), 1,2-dimethoxyethane (DME), acetonitrile, ethyl acetate, dichloromethane (DCM), or a combination of two or more thereof. The base reservoir 506 may include 2,3,4,6,7,8,9,10-octahydropyrimido[1,2-a]azepine (DBU), triethylamine, potassium phosphate, N,N-diisopropylethylamine (DIPEA), sodium carbonate, potassium carbonate, or a combination of two or more thereof. The trialkylsilylalcohol reservoir 510 may include trimethylsilylmethanol, trimethylsilylethanol, trimethylsilylpropanol, or trimethylsilylisopropanol. The alkyl chloroformate reservoir 512 may include methyl chloroformate, ethyl chloroformate, or propyl chloroformate.

The present invention, thus generally described, will be understood more readily by reference to the following examples, which are provided by way of illustration and are not intended to be limiting of the present invention.

### EXAMPLES

Example 1. A three neck 1 liter flask equipped with a thermocouple, overhead stirrer, and gas inlet and gas outlet connected to a bubbler with nitrogen gas was charged with 1,2-dimethoxyethane (DME, 600 mL, 10 mL/g) and tribasic potassium phosphate (K₃PO₄, 146.65 g, 1.2 eq). Trimethylsilyl methanol (TMSCH₂OH, 72.64 mL, 1.0 eq) was then slowly added to the reactor. Ethyl chloroformate was slowly added to the flask via additional funnel at a temperature of less than or equal to 36° C. The reaction temperature was then increased to 50° C. for 6 hours, which resulted in about 95% conversion, as indicated by GC/MS analysis of the mixture after reaction. The heated mixture was then stirred at room temperature overnight for the final conversion of 96-97%. The simplified reaction was

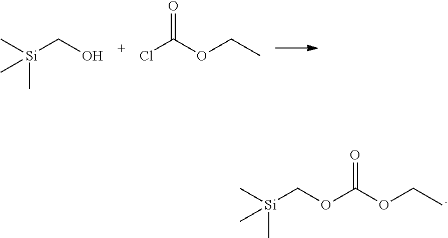

Diatomaceous earth (i.e., Celite) was used to filter out the K₃PO₄. The solvent was then removed by rotary evaporation (34° C., 90 mbar). The solution was then distilled using a 5-plate Oldershaw column. The product was collected at about 76.2° C. to about 78° C. at about 21.6 torr to about 18 torr. The final yield was 67% with ≥99.9% purity ethyl trimethylsilylmethyl carbonate (ETMSMC), as indicated by GC/MS.

Example 2: Base Screening. The reaction procedure in Example 1 was repeated with different bases to determine how different bases affect the reaction. Acetonitrile (2.5 mL, 10 mL/g) was added to the reactor followed by the desired amount of the selected base (Table 1, 2.4 mmol). Trimethylsilyl methanol (TMSCH₂OH, 0.303 mL, 2.4 mmol) was then added to the reactor followed by the slow addition of ethyl chloroformate (0.23 mL, 2.4 mmol) via additional funnel at a temperature of less than or equal to 36° C. The reaction mixture was initially held at room temperature, but indicated almost no reaction, as indicated by gas chromatography mass spectroscopy (GC/MS) analysis. The temperature of the reactor was then increased to 75° C., and the reaction mixture was heated at 75° C. for 3 hours. The bases investigated were 2,3,4,6,7,8,9,10-octahydropyrimido[1,2-a]azepine (DBU), triethylamine (TEA), potassium phosphate (K₃PO₄), N,N-diisopropylethylamine (DIPEA), sodium carbonate (Na₂CO₃), and potassium carbonate (K₂CO₃).

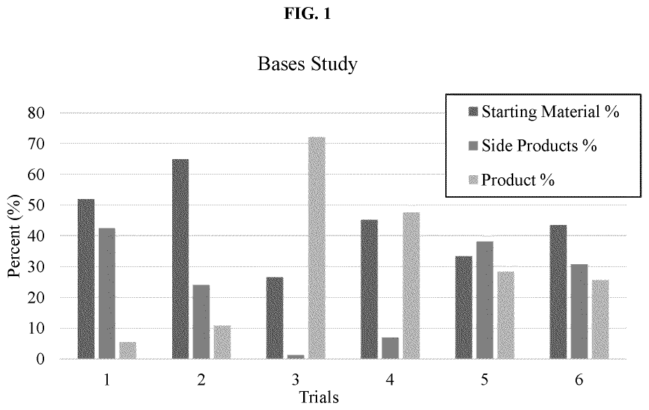

Results are shown in Table 1 and FIG. 1. FIG. 1 is a graph of relative amounts of starting material, side products, and products in mixtures following reaction using different bases. Results indicate that all bases tested resulted in the formation of some amount of the ETMSMC product. Furthermore, the results indicated 72% of the mixture was the product ETMSMC, with only 1.26% of the side product bis(trimethylsilylmethyl) carbonate (BTMSMC) and 26.6% trimethylsilyl methanol when the base was K₃PO₄. The side product bis(trimethylsilylmethyl) carbonate had the structure according to Formula (III)

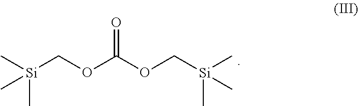

TABLE 1
GC/MS Analysis of Mixtures using Different Bases with Different
Amounts of Base, Starting Material (S.M. %), Side Product
(BTMSMC %), and Product Silylcarbonate (Product %).

| | Type of | | | | | |
|---|---|---|---|---|---|---|
| Trial | Base | Base Amount | | S.M. % | BTMSMC % | Product % |
| 1 | DBU | 3.59 | mL | 52.0 | 42.5 | 5.50 |
| 2 | TEA | 0.33 | mL | 65.0 | 24.1 | 10.9 |
| 3 | K₃PO₄ | 0.51 | g | 26.6 | 1.26 | 72.14 |
| 4 | DIPEA | 0.42 | mL | 45.3 | 6.97 | 47.7 |
| 5 | Na₂CO₃ | 0.25 | g | 33.4 | 38.2 | 28.4 |
| 6 | K₂CO₃ | 0.27 | g | 43.5 | 30.8 | 25.7 |

Example 3: Solvent Screening. The reaction procedure in Example 1 was repeated with different solvents to determine how different solvents affect the reaction. The selected solvent (2 mL, 10 mL/g), which is shown in Table 2, was added to a 2 mL scintillation vial, followed by the addition of K₃PO₄ (0.489 g, 2.3 mmol). Trimethylsilyl methanol (0.24 mL, 1.9 mmol) was then added to the reactor followed by the slow addition of ethyl chloroformate (0.22 mL, 2.3 mmol) via additional funnel. The temperature was increased to 50° C. and was analyzed after 2 hours. The dichloromethane (DCM) solution was heated to 35° C. due to the lower boiling point.

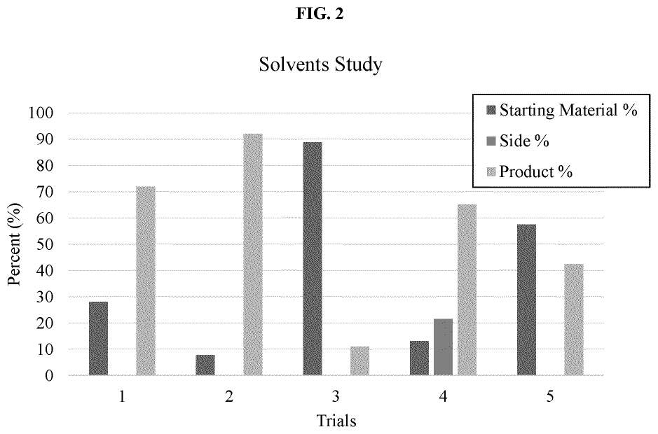

Results are shown in Table 2 and FIG. 2. FIG. 2 is a graph of relative amounts of starting material, side products, and products in mixtures following reaction using different solvents. Results indicate that all solvents tested resulted in the formation of some amount of the ETMSMC product. Furthermore, the results indicated that with DME solvent, 92% of the mixture was the product ETMSMC, with 0% of bis(trimethylsilylmethyl) carbonate and only 7.9% of the starting material.

TABLE 2
GC/MS Analysis of Mixtures using Different Solvents.

| Trial | Solvent | S.M. % | BTMSMC % | Product % |
|---|---|---|---|---|
| 1 | THF | 28.1 | 0 | 71.9 |
| 2 | DME | 7.90 | 0 | 92.1 |
| 3 | MeCN | 88.9 | 0 | 11.1 |
| 4 | EtOAc | 13.2 | 21.6 | 65.2 |
| 5 | DCM | 57.5 | 0 | 42.5 |

Example 4: Base Equivalents Screening. The reaction procedure in Example 1 was repeated with different base equivalents to determine how different base equivalents affects the reaction. The base equivalents tested were 0.7 eq., 0.8 eq., 1.0 eq., and 1.2 eq. Dimethoxyethane (10 mL, 10 mL/g) was added to the reactor followed by the desired amount of K₃PO₄ (Table 3). Trimethylsilyl methanol (1.21 mL, 9.5 mmol) was added followed by the slow addition of ethyl chloroformate (1.09 mL, 11 mmol) via additional funnel. The reaction temperature was set to 80° C. and GC/MS was used to analyze the mixture at 2, 6, and 24 hours into each reaction.

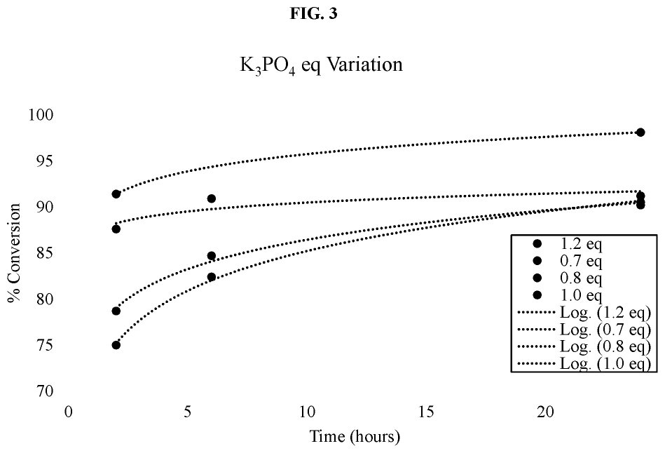

Results are shown in Table 3 and FIG. 3. FIG. 3 is a graph of conversion efficiency (%) with different amounts of K₃PO₄ in the mixture. Results indicated that less than stoichiometric amounts of base may be used to prepare ETMSMC. However, at lower base equivalents, the reaction rate slowed towards the endpoint, and a slight excess (1.2 eq.) of base was used to push reaction to greater than 98% after 24 hours.

TABLE 3
GC/MS Analysis of Reaction Conversion using
Different Equivalents of K₃PO₄ Base.

| | | | Time (hrs) | | |
|---|---|---|---|---|---|
| Trial | Base eq. | Base (mmol) | 2 | 6 | 24 |
| 1 | 0.7 | 6.7 | 75.0 | 82.4 | 90.5 |
| 2 | 0.8 | 7.6 | 78.7 | 84.7 | 90.2 |
| 3 | 1.0 | 9.5 | 87.6 | 90.9 | 91.2 |
| 4 | 1.2 | 11 | 91.4 | N/A | 98.1 |

Example 5: ETMSMC Characterization. The ETMSMC product of the synthesis in Example 1 was characterized using GC/MS, ¹H NMR, and ¹³C NMR.

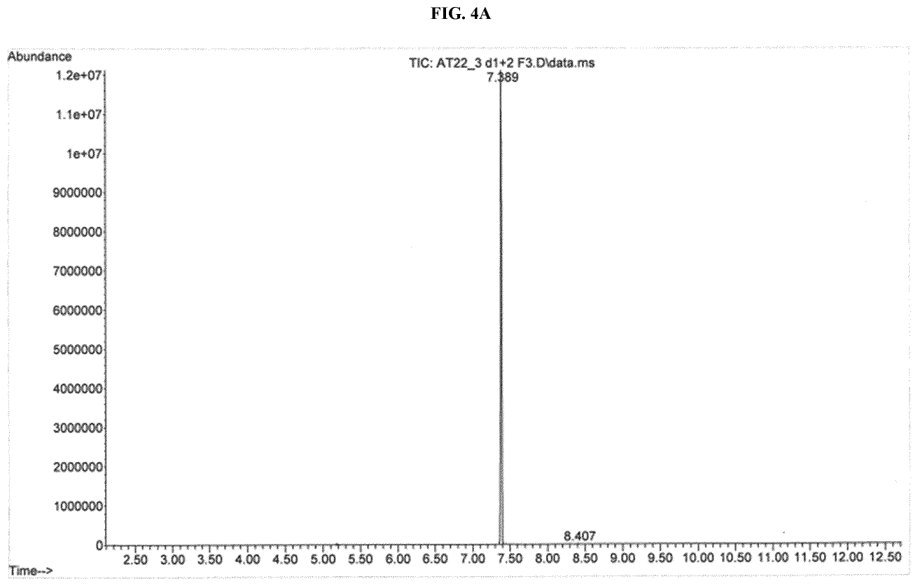

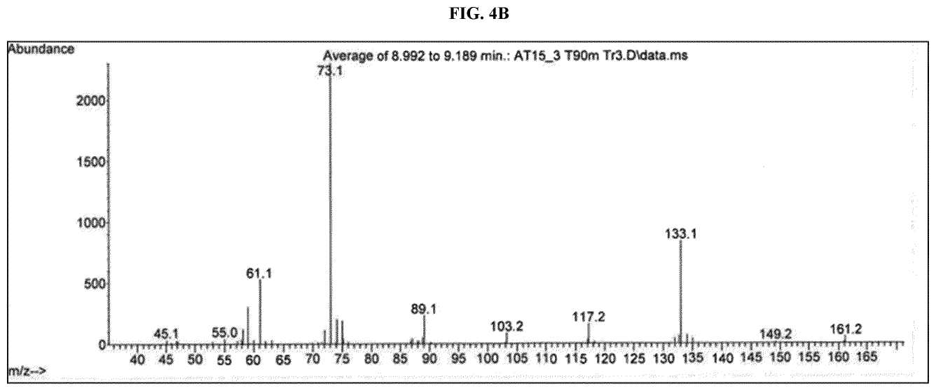

FIGS. 4A and 4B are graphs characterizing the product of the reaction after diatomaceous earth filtering and distillation. FIG. 4A is a graph of gas chromatography-mass spectroscopy analysis of the product. Gas chromatography retention time of 7.389 minutes and a mass-to-charge ratio (m/z) of 161, indicating a molecular ion (M+1) with high purity (99.94%). FIG. 4B is a graph of mass spectroscopy of the product. The product of the reaction after diatomaceous earth filtering and distillation was also characterized with nuclear magnetic resonance (NMR). ¹³C NMR (neat, 20 MHz): δ 155.75, 62.69, 60.22, 13.63, 4.02. ¹H NMR (neat, 80 MHz): δ 0.28 (s, 9H), 0.77-0.95 (t, J=7.2 Hz, 3H), 3.42 (s, 2H), 3.60-3.87 (q, J=7.2 Hz, 2H). As shown in FIG. 4A, peaks at 2.987 and 4.375 correspond to the DME solvent and the trimethylsilyl methanol, respectively. The peak at 6.901 corresponds to the ETMSMC product and the peak at 8.407 corresponds to the BTMSMC side product. ¹H NMR indicated that the ratio between the ETMSMC peak and the BTMSMC side product was 99.937% to 0.063%.

Example 6: Kilogram Scale. Two separate 1 kilogram-scale reactions were conducted in 20 L jacketed reactors. The commercial trimethylsilyl methanol (TMSCH₂OH) was used for the first scale-up but smaller-scale synthesis studies had suggested the reaction with the commercial TMSCH₂OH was slower and had a lower conversion rate than studies with in-house synthesized TMS-CH₂OH. Even though there were differences in the reaction and conversion rates, the in-house-synthesized and commercial TMSCH₂OH provided ETMSMC products with little difference in analysis by ¹H NMR and GC/MS. A common impurity, trimethylsilyl acetate, was found in both self-synthesized and commercial TMS-CH₂OH. This side product is a common side product formed in the synthesis of TMSCH₂OH.

Commercial TMS-CH₂OH: A glass 20 L jacketed reactor equipped with drain valve, internal probe and gas inlet/outlet adaptors was purged with nitrogen. The jacket of the reactor was connected to a Huber heating/chilling circulator. Dimethoxyethane (DME), trimethylsilyl methanol (TMSCH₂OH) and ethyl chloroformate (ECF) were all added via peristaltic pump. The reactor was charged with DME (9.0 L, 10 mL/g) and K₃PO₄ (2684.11 g, 10.1 mol). TMSCH₂OH (879.1 g, 8.43 mol) was added, then the ECF (963.0 mL, 10.1 mol) was slowly added. The total addition time of ECF was approximately 20 minutes with little indication of a change in the solution's temperature. The solution temperature was then increased to 80° C. and run for 3 days. After the 3 days, the final conversion rate was 91.4%.

The work-up was done by filtering the solution with Celite to separate the K₃PO₄. The K₃PO₄/celite cake was rinsed with 3.0 L THF to try to collect any product trapped in the solids. The filtrate was then rotovaped at 90 mbar and 36° C. to discard most of the solvent. The solution was then fractionally distilled with the 5-plate Oldershaw column and the product was collected at 79.4° C. to 80.0° C. at 23.2 torr to 21.3 torr.

Self-synthesized TMS-CH₂OH: A glass 20 L jacketed reactor equipped with drain valve, internal probe and gas inlet/outlet adaptors was purged with nitrogen. The jacket of the reactor was connected to a Huber heating/chilling circulator. Dimethoxyethane (DME), trimethylsilyl methanol (TMS-CH₂OH) and ethyl chloroformate (ECF) were all added via peristaltic pump. The reactor was charged with DME (9 L, 10 mL/g) and K₃PO₄ (2025.1 g, 9.53 mol) and was stirred by an overhead stirrer. TMSCH₂OH (828.15 g, 7.95 mol) was added, followed by the slow addition of ECF (907.7 mL, 9.53 mol). The addition of the ECF was again approximately 20 minutes. The reaction mixture's temperature was then increased to 80° C. and left to run for 21 hours, resulting in the conversion of 95.8%.

The work-up was done by filtering the solution with Celite to separate the K₃PO₄. The K₃PO₄/Celite cake was rinsed with 3.0 L MTBE to try to collect any product trapped in the solids. The filtrate with then rotovaped at 90 mbar and 36° C. to discard most of the solvent. The solution was then fractionally distilled via the 5-plate Oldershaw column and the product was collected at 79.4° C. to 80.0° C. at 21.8 torr to 18.0 torr.

The product of kilogram-scale reaction was characterized with NMR. ¹H NMR characterization of the product of the reaction using commercially available trimethylsilyl methanol: ¹H NMR (neat, 80 MHz): δ 0.27 (s, 9H), 2.90 (s, 2H), 4.18 (s, 1H). ¹H NMR analysis of the product of the reaction using in-house-synthesized trimethylsilyl methanol: ¹H NMR (neat, 80 MHz): δ 0.28 (s, 9H), 2.90 (s, 2H), 4.14 (s, 1H).

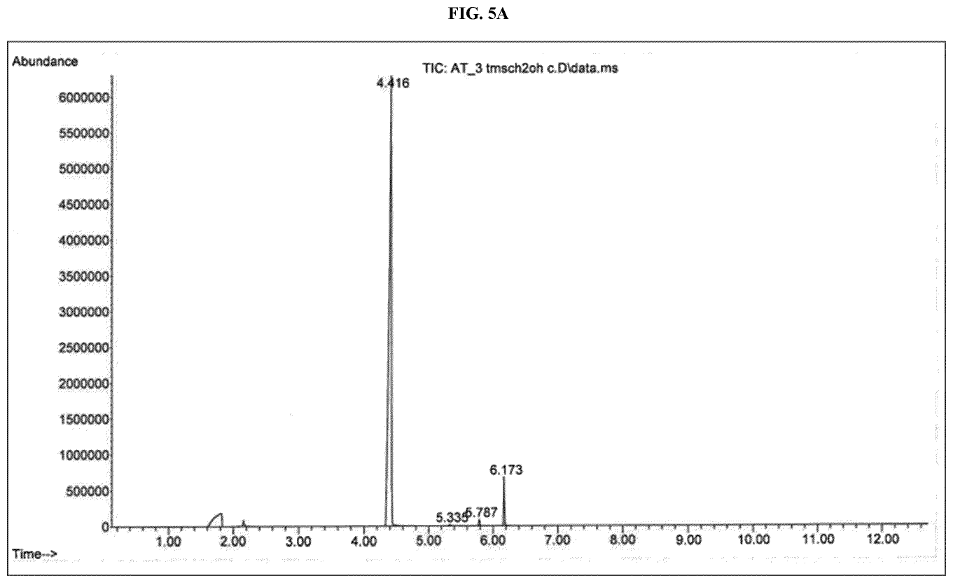

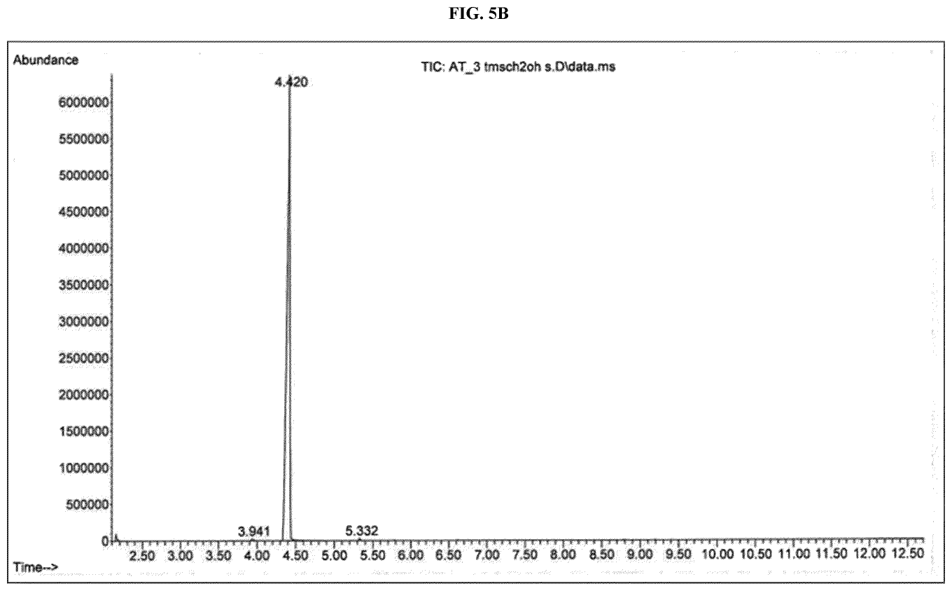

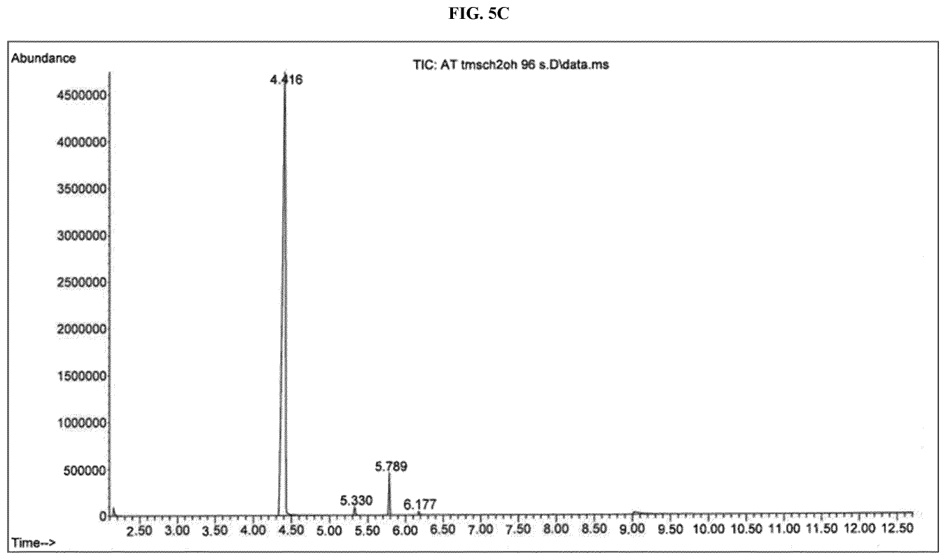

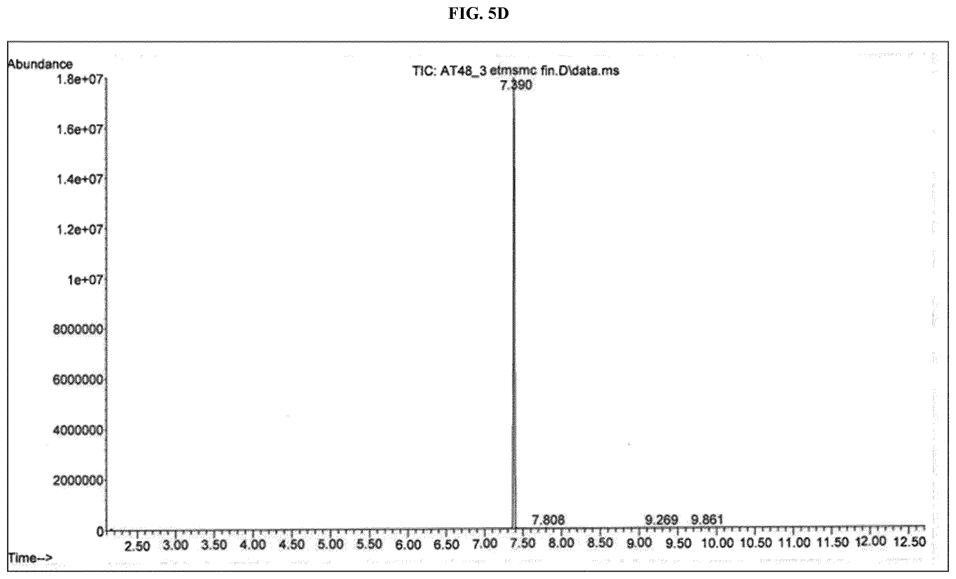

FIG. 5A is a graph of gas chromatography analysis of the product of the reaction using commercially available trimethylsilyl methanol. Retention time (RT) 4.416 minutes (94.9%, 104 m/z (M+1)). FIG. 5B is a graph of gas chromatography analysis of the product of the reaction using in-house-synthesized trimethylsilyl methanol. RT 4.42 minutes (99.47%, 104 m/z (M+1)). FIG. 5C is a graph of gas chromatography analysis of the product of the reaction using commercially available trimethylsilyl methanol, indicating the presence of an acetate impurity. RT 4.416 minutes (96.2%, 104 m/z (M+1)).

A further distillation with a 10-plate Oldershaw column was conducted with the off fractions from the two 1 kg scale reactions for the final collection of ETMSMC. The conditions for product collection were 80.1° C. to 78.9° C. and 15.3 torr to 19.9 torr. The resulting collection of ≥99.8 ETMSMC was 1417.6 g (49.1% yield). FIG. 5D is a graph of gas chromatography analysis of the product of the reaction after distillation with a 10-plate Oldershaw column. RT 7.390 minutes (99.88%, 161 m/z (M+1)).

¹H NMR analysis of the product of the reaction after distillation with a 10-plate Oldershaw column: ¹H NMR (neat, 80 MHz): δ 0.32 (s, 9H), 0.74-0.92 (t, J=7.2 Hz, 3H), 3.39 (s, 2H), 3.57-3.84 (q, J=7.2 Hz, 2H). ¹³C NMR analysis of the product of the reaction after distillation with a 10-plate Oldershaw column: ¹³C NMR (neat, 20 MHz): δ 155.38, 62.76, 60.28, 13.69, 3.96.

Example 7: Chloroformate Variation Studies. Different chloroformates were analyzed using the same reaction mechanism and conditions as in Example 1. A 100 mL three-neck, round-bottom flask equipped with a thermocouple, overhead stirrer, and a PTFE tube gas inlet and gas outlet connected to a bubbler with nitrogen was purged. The flask was charged with dimethoxyethane (40 mL, 10 mL/g) and tripotassium phosphate (9.78 g, 46 mmol). Trimethylsilyl methanol (4.84 mL, 38 mmol) was added, then the selected chloroformate (Table 4, 46 mmol) was slowly added via additional funnel. The solution was then heated to 80° C. for 6 hours and analyzed a further 6 hours after. The different chloroformates were methyl chloroformate, isobutyl chloroformate, benzyl chloroformate, 4-nitrobenzyl chloroformate, 4-nitrophenyl chloroformate, allyl chloroformate, and butyl chloroformate.

TABLE 4
Chloroformate variation trials conversion
rates and final percent yields.

| | | | | | Side | Final |
|---|---|---|---|---|---|---|
| | | Base Amt. | | Conversion | Product | Yield |
| Trial | Chloroformate | Added | | (%) | (%) | (%) |
| 1 | Methyl | 3.56 | mL | 92.5 | 2.98 | 74.0 |
| 2 | Isobutyl | 5.97 | mL | 98.1 | 1.23 | 90.8 |
| 3 | Benzyl | 6.57 | mL | 97.1 | 1.85 | 85.3 |
| 4 | 4-Nitrobenzyl | 9.93 | g | 85.0 | 1.75 | 83.1 |
| 5 | 4-Nitrophenyl | 9.28 | g | 100 | 0.00 | 85.3 |
| 6 | Allyl | 4.91 | mL | 95.8 | 4.02 | 85.9 |
| 7 | Butyl | 7.01 | mL | 94.8 | 5.16 | 80.3 |

The final collection weights were slightly off due to solution impurities. Slight dimethoxyethane and trimethylsilyl methanol stuck to each 5 g small scale for each trial. The percent yields were slightly below the final yield (%) column in Table 4. The estimated yields were around 70-80% for each chloroformate variation.

Products of the reactions in Example 7 with different chloroformates were characterized with NMR. On the ¹H NMR spectra for each trial, there was a slight excess of DME and starting material (3.2 and 3.4 peaks). The other correlating peaks indicated the desired product for each reaction. The conversion and final yields of each chloroformate variation are in Table 4.

¹H NMR results of the product methyl (trimethylsilyl)methyl carbonate: ¹H NMR (neat, 80 MHz): δ 0.24 (s, 9H), 3.37 (s, 2H), 3.49 (s, 3H).

¹H NMR results of the product isobutyl (trimethylsilyl)methyl carbonate: ¹H NMR (neat, 80 MHz): δ 0.24 (s, 9H), 3.37 (s, 2H), 3.49 (s, 3H).

¹H NMR results of the product benzyl (trimethylsilyl)methyl carbonate: ¹H NMR (CDCl₃, 80 MHz): δ 0.7 (s, 9H), 3.84 (s, 2H), 5.14 (s, 2H), 7.35 (s, 5H).

¹H NMR results of the product 4-nitrobenzyl (trimethylsilyl)methyl carbonate: ¹H NMR: (CDCl₃, 80 MHz): δ 0.03 (s, 9H), 3.76 (s, 2H), 5.14 (s, 2H), 7.46-7.49 (d, J=8.7 Hz, 2H), 7.99-8.13 (d, J=8.7 Hz, 2H).

¹H NMR results of the product nitrophenyl (trimethylsilyl)methyl carbonate: ¹H NMR (CDCl₃, 80 MHz): δ 0.14 (s, 9H), 3.71 (s, 2H), 7.02-7.26 (d, J=6.4 Hz, 2H), 7.94-8.02 (d, J=6.4 Hz, 2H).

¹H NMR results of the product allyl (trimethylsilyl)methyl carbonate: ¹H NMR (CDCl₃, 80 MHz): δ 0.02 (s, 9H), 3.73 (s, 2H), 4.43-4.47 (d, J=3.2 Hz, 2H), 5.03 (s, 1H), 5.34 (s, 1H), 5.6-6.08 (m, 1H).

¹H NMR results of the product butyl (trimethylsilyl)methyl carbonate: ¹H NMR (CDCl₃, 80 MHz): δ 0.02 (s, 9H), 0.77-0.94 (t, J=6.4 Hz, 3H), 1.30-1.66 (m, 4H), 3.69 (s, 2H), 3.97-4.13 (t, J=5.6 Hz, 2H).

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. A method of making a compound comprising:
mixing a solvent, trialkylsilylalcohol, alkyl chloroformate, and a base to form a reaction mixture;
heating the reaction mixture to form a heated mixture comprising the compound having a structure of Formula (I); 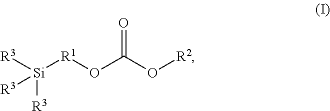
wherein
R¹ is CH₂, CH₂CH₂, or CH₂CH₂CH₂;
R² is C₁-C₄ alkyl, C₂-C₄ alkenyl, a substituted aryl, or an unsubstituted aryl; and
R³ is an alkyl.

2. The method of claim 1, wherein heating the reaction mixture comprises heating at a temperature of about 2° C. to about 35° C. less than the solvent's boiling point.

3. The method of claim 1, wherein the trialkylsilylalcohol is trimethylsilylmethanol, trimethylsilylethanol, trimethylsilylpropanol, or trimethylsilylisopropanol.

4. The method of claim 1, wherein the alkyl chloroformate is methyl chloroformate, ethyl chloroformate, or propyl chloroformate.

5. The method of claim 1, wherein R¹ is CH₂, R² is CH₂CH₃, the trialkylsilylalcohol is trimethylsilylmethanol; and the alkyl chloroformate is methyl chloroformate.

6. The method of claim 1, wherein the base comprises 2,3,4,6,7,8,9,10-octahydropyrimido[1,2-a]azepine (DBU), triethylamine, potassium phosphate, N,N-diisopropylethylamine (DIPEA), sodium carbonate, potassium carbonate, or a combination of two or more thereof.

7. The method of claim 1, wherein the solvent comprises tetrahydrofuran (THF), 1,2-dimethoxyethane (DME), acetonitrile, ethyl acetate, dichloromethane (DCM), or a combination of two or more thereof.

8. The method of claim 1, wherein the solvent is 1,2-dimethoxyethane (DME); and wherein heating the reaction mixture comprises heating at a temperature of about 50° C. to about 80° C.

9. The method of claim 1, wherein forming the reaction mixture comprises:
combining the base and the trialkylsilylalcohol in the solvent to form a solution; and
mixing the alkyl chloroformate with the solution at a temperature of about 15° C. to about 36° C.

10. The method of claim 9, further comprising filtering at least a portion of the base out of the heated mixture.

11. The method of claim 10, further comprising removing about 10 wt % to about 99 wt % of the solvent from the heated mixture.

12. The method of claim 11, wherein a yield of the compound having the structure of Formula (I) is about 40% to about 70% with a purity of about 99.9% to about 99.99%.

13. The method of claim 1, wherein the reaction mixture comprises a molar excess of base relative to the trialkylsilylalcohol of about 1.1:1 to about 2:1.

14. The method of claim 1, wherein R³ is C₁-C₈ alkyl.

15. A system comprising:
a reactor configured to control a reaction mixture disposed in the reactor at an elevated temperature;
a pumping assembly in fluid communication with a plurality of reactant reservoirs, the pumping assembly configured to pump a plurality of reactants from the plurality of reactant reservoirs to the reactor; and
the plurality of reactant reservoirs comprising a solvent reservoir comprising a solvent, a base reservoir, a trialkylsilylalcohol reservoir, and an alkyl chloroformate reservoir;
wherein the system is configured to prepare a compound having a structure of Formula (I) 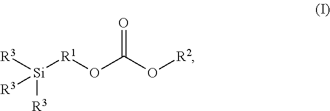
wherein:
R¹ is CH₂, CH₂CH₂, or CH₂CH₂CH₂;
R² is C₁-C₄ alkyl, C₂-C₄ alkenyl, a substituted aryl, or an unsubstituted aryl; and
R³ is an alkyl.

16. The system of claim 15, wherein the elevated temperature is a temperature of about 2° C. to about 35° C. less than the solvent's boiling point.

17. The system of claim 15, further comprising:
a filter assembly configured to remove at least a portion of a base from the reaction mixture; and
a fractionating column configured to remove about 10 wt % to about 99 wt % of the solvent from the reaction mixture.

18. The system of claim 15, wherein the solvent reservoir comprises tetrahydrofuran (THF), 1,2-dimethoxyethane (DME), acetonitrile, ethyl acetate, dichloromethane (DCM), or a combination of two or more thereof,
wherein the base reservoir comprises 2,3,4,6,7,8,9,10-octahydropyrimido[1,2-a]azepine (DBU), triethylamine, potassium phosphate, N,N-diisopropylethylamine (DIPEA), sodium carbonate, potassium carbonate, or a combination of two or more thereof;
wherein the trialkylsilylalcohol reservoir comprises trimethylsilylmethanol, trimethylsilylethanol, trimethylsilylpropanol, or trimethylsilylisopropanol; and
wherein the alkyl chloroformate reservoir comprises methyl chloroformate, ethyl chloroformate, or propyl chloroformate.

19. A method of making a compound comprising:
reacting trimethylsilylmethanol with ethyl chloroformate in the presence of potassium phosphate in dimethoxyethane at a temperature of about 50° C. to about 80° C. to form the compound having a structure of Formula (II) [chemical structure]
